(19) United States
(12) Patent Application Publication
(10) Pub. No.: US 2012/0310954 A1
(43) Pub. Date: Dec. 6, 2012

(54) METHOD AND SYSTEM TO NARROW GENERIC SEARCHES USING RELATED SEARCH TERMS

(75) Inventor: Sandip Gaikwad, Sunnyvale, CA (US)

(73) Assignee: eBay Inc., San Jose, CA (US)

(21) Appl. No.: 13/153,071

(22) Filed: Jun. 3, 2011

(51) Int. Cl. G06F 17/30

(52) U.S. Cl. 707/754; 707/E17.059

(57) ABSTRACT

A method and system for narrowing down generic searches using related search terms is provided. An example system comprises a communications module, a listings retrieval module, a supplemental search term generator, and a filter generator. The communications module may be configured to receive a user-supplied search term. The listings retrieval module may be configured to retrieve, based on the user-supplied search term, one or more listings. The supplemental search term generator may be configured to identify, based on frequency of appearance of different words in the titles of the retrieved listings, a supplemental search term. The filter generator may be configured to generate, based on the supplemental search term, a list of filters to be presented to a user for selection.

### TECHNICAL FIELD

This application relates to the technical fields of software and/or hardware technology and, in one example embodiment, to system and method to narrow generic searches using related search terms.

### BACKGROUND

Networked commerce systems, such as on-line trading systems, depend upon user specified searches to locate items of commerce. While some users are highly skilled at locating desired items, a large segment of users lack knowledge helpful in navigating such systems. As a result, inefficient use of the system and a lack of user traffic to some commerce items can be experienced. In some existing systems, a web page that allows a user to enter search terms may also be configured to permit a user to select a category, from a list of pre-existing categories, within which the search based on the user-supplied search terms is to be performed.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to narrow generic searches using related search terms may be implemented;

FIG. 2 is block diagram of a system to narrow generic searches using related search terms, in accordance with one example embodiment;

FIG. 3 is a flow chart of a method to narrow generic searches using related search terms, in accordance with an example embodiment;

FIG. 4 is an example user interface illustrating how the listings of commerce items, categories and subcategories, and system-supplied search terms may be presented to a user, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to narrow generic searches using related search terms is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

An on-online trading system may be configured to maintain listings of items that are being offered for sale. Each such listing comprises a title consisting of words and phrases describing characteristics of the commerce item represented by the listing. System and method may be provided for narrowing generic searches for commerce items described in the listings. The phrase “generic search” refers to a search based on a user-supplied keyword that typically returns a great number of search results, where not all of the results may be of interest to the user. In one example embodiment, when a user submits a request to perform a search based on a word or a phrase (collectively referred to as a search term), all listings that have titles containing the user-supplied search term are examined in order to identify additional words that may be useful in narrowing the search. These additional words may be determined based on how frequently each word appears in the titles of the returned listings. An example system to narrow down generic searches may include a system for determining supplemental search terms based on user-supplied search terms, which may be configured to identify a certain number of words (e.g., five or seven) that appear most frequently in the titles of the returned listings. These words, alone or combined with the user-supplied (or supplemental) search term, may be referred to as system-supplied search terms.

The system-supplied search terms may be used to generate a list of one or more filters to be presented to the user. A filter from the list of filters may be, e.g., a system-supplied search term. When the system to narrow generic searches receives, from a user's computer system, a selection of a filter from the list of filters, the retrieved listings are filtered based on the received selected filter. In some embodiments, a filter from the list of filters may be an inferred category associated with a system-supplied search term, as described below.

The listings returned in response to a user's search request may be filtered by requesting to view only those listings that are associated with a certain pre-existing category. A listing may be mapped to a category based on the words that appear in the title of the listing. For example, words describing a color may be associated with a “color” category; and a listing that includes a word describing a color in its title may be mapped to the “color” category. Similarly, a listing that includes a word describing a part of an automobile may be mapped to an “automobile” category. In some embodiments, the system for determining supplemental search terms based on user-supplied search terms may be utilized to identify additional (also referred to as inferred) categories associated with a listing.

For example, additional categories may be inferred by analyzing, other than the user-supplied search term or synonyms of the user-supplied search terms, in the titles of the returned listings. In some embodiments, one or more inferred categories may be used to refine the returned listings when 1) a user-supplied search term contains more than one word and some of the words can be identified as associated with one category while some of the other words can be identified as associated with another category; or 2) a user-supplied search term contains only one word that can be identified as associated with more than one category. For instance, when a user submits a search request for “black carpet,” all returned listings that have titles containing “black carpet” are examined to identify additional terms. A “color” category may be presented if “black” is identified as associated with the category “color.” Further, if the word “carpet” is identified as associated with the category “automobile,” the “automobile” category may also be presented to the user. Both the “color” category and the “automobile” category may be presented to the user either together at the same time, or separately at different times. In another example, if a user submits a search term “carpet” and the word “carpet” is associated with both the “house decoration” category and the “automobile” category, then both the “house decoration” and the “automobile” category may be presented to help the user refine the returned listings. In some embodiments, additional categories may be inferred based on related/context words that appear in the titles of the returned listings. For example, if the search based on the user-supplied search term “black carpet” returns a listing with the title “black EUROPEAN 6×8 area RUG French MEDALLION carpet,” the context/related words “European,” “area,” “rug,” “French,” and “medallion” can be used to determine supplemental search terms and additional categories.

In still another embodiment, a subcategory may be presented in addition to an inferred category if the user-supplied or the system-generated term has been identified as associated with two or more categories and one of the categories is a subcategory of another. For example, if the word “carpet” is identified as associated with both the category “sedan” and the category “automobile,” and “sedan” is a recognized subcategory of the “automobile” category, then both the “automobile” category and the subcategory “sedan” may be presented to the user.

However, in other embodiments, subcategories may be presented within a main category, regardless of whether the user-supplied or system-generated term is identified as associated with these subcategories or not, as long as the term is identified as associated with the main category. For example, in response to a user search request for “carpet,” an “automobile” category is presented, because “carpet” is identified as an accessory of an automobile. The “automobile” category may include subcategories corresponding to different automobile makers, in which case an example system for narrowing generic searches may present to the user a subcategory related to an automobile maker, such that the user may search only for those “carpet” listings that describe automobile carpet for a particular automobile.

In yet another example embodiment, in determining how frequently a term appears in the titles of the returned listings, the system for narrowing generic searches may examine not only individual terms, but a term and its synonyms. Synonymous relationships (which may be between single words or between phrases consisting of more than one word) may be stored in the mapping database or in a separate database. For the purpose of generating supplemental search terms, the frequency of a term may be determined as the total number of appearances of the term in the titles of the returned listings plus the total number of appearances of its synonyms in the titles of the returned listings. In some embodiments, only one of the synonymous terms is selected as a system-supplied search term. For example, if a user submits a search request for “computer,” and the word “laptop” and its synonym “notebook,” together, appear more frequently than other words in the titles of the returned listings, the system will select either the word “laptop” or the word “notebook,” but not both, for presentation to the user as a system-supplied supplemental search term. For the purposes of determining a supplemental search term, the system may be configured to ignore certain words in the titles of the listings, such as articles and prepositions.

In determining whether two terms are synonyms, the system to narrow generic searches may first determine a so-called level of synonymy. Two terms are considered to be one-level synonymous with each other if they are direct synonyms of each other (e.g., the term “car” is a one-level synonym of the term “automobile”). Two terms are two-level synonymous with each other if the first term and the second terms are not one-level synonymous with each other, but they are both one-level synonymous with a third term (e.g., “truck” and “sedan” are two-level synonyms if they are both mapped as synonyms of the word “automobile”). The calculation of how frequently a term appears in the titles of the returned listings may be performed using one-level and also two-level synonyms. The system to narrow generic searches may be configured to only rely on those synonymous relationships that have less than a predetermined level of depth.

In another example embodiment, synonyms may be also used together with categories to refine the returned listings. A term can be identified as associated with a category if one of its synonyms is identified, as associated with the category. Because the deeper the level a synonymous relationship is, the less likely the two terms are directed to the same subject matter, the system can be configured so that only a synonymous relationship less than a predetermined level of depth is be considered to be associated with a common category.

In a further example embodiment, if a search based on a user-supplied search term containing two or more words returns no results, a system-supplied search term can be generated by removing one or more words from the user-supplied search term. For example, if a search for “embroidered automobile carpet” returns no listings, system-supplied search terms, such as “automobile carpet,” “embroidered carpet,” or simply “carpet” may be provided to the user for selection. Alternatively, the system may automatically, without requiring a selection by the user, perform searches based on the system-generated supplemental search term and present the results to the user. In some embodiments, the system may be configured to remove no greater than a predetermined number of words from the user-supplied search term in generating the system-supplied search terms.

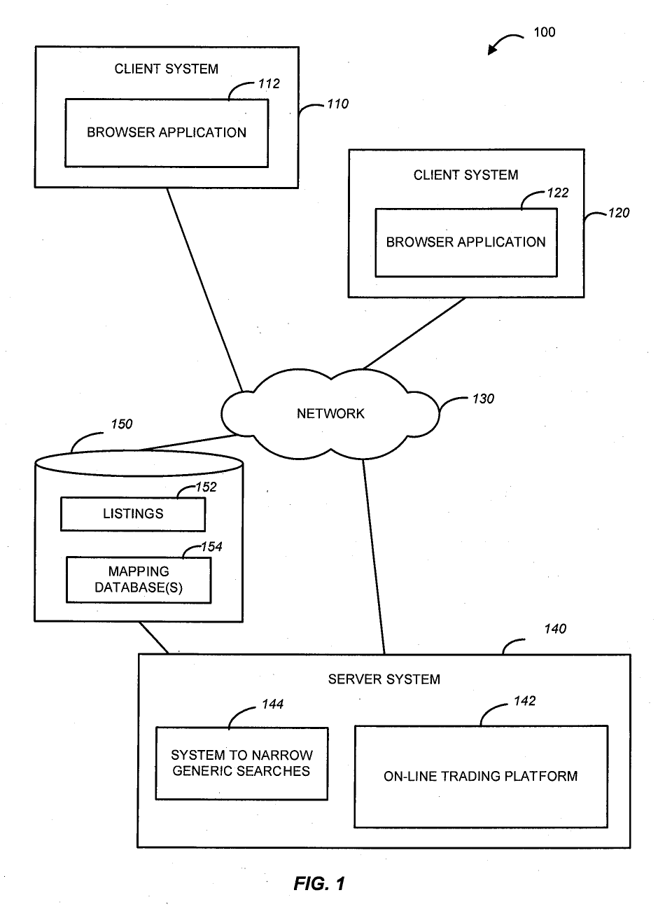

An example system to narrow generic searches may be configured to store system-generated supplemental search terms and inferred categories for future use. When a user-supplied search term is encountered for the first time in the context of a search request, and the system generates a set of filters (e.g., in the form of supplemental search terms, phrases containing a supplemental search term, or one or more inferred categories), these filters are presented to the user and, also, are stored for future use. Thus, next time the same user-supplied search term is encountered by the system to narrow generic searches, the system does not perform the examination of the returned listings during runtime, but instead retrieves the stored set of filters for that user-supplied search term and presents it to the user for selection of a filter. An example method and system to narrow generic searches using related search terms may be implemented in the context of a network environment 100 illustrated in FIG. 1.

As shown in FIG. 1, the network environment 100 may include client systems 110 and 120 and a server system 140. The server system 140, in one example embodiment, may host an on-line trading platform 142. The client systems 110 and 120 may run respective browser applications 112 and 122 and may have access to the server system 140 via a communications network 130. The communications network 130 may be a public network (e.g., the Internet, a wireless network, etc.) or a private network (e.g., a local area network (LAN), a wide area network (WAN), Intranet, etc.).

The client system 110 may utilize the browser application 112 to access services provided by the server system 140, such as, e.g., the on-line trading platform 142. The on-line trading platform 142 may be configured to retrieve commerce item listings 152 stored in a storage system 150 and to provide the retrieved listings to users for viewing. The server 140 may also host a system 144. The system 144 may be configured to aid a user in narrowing results of searches performed based on one or more keywords supplied by the user. The system 144 may be configured to examine respective titles of all listings returned in response to a user's search request and, based on the frequency with which different words appear in the titles of the returned listings, provide the user with suggestions of supplemental search terms and/or additional categories.

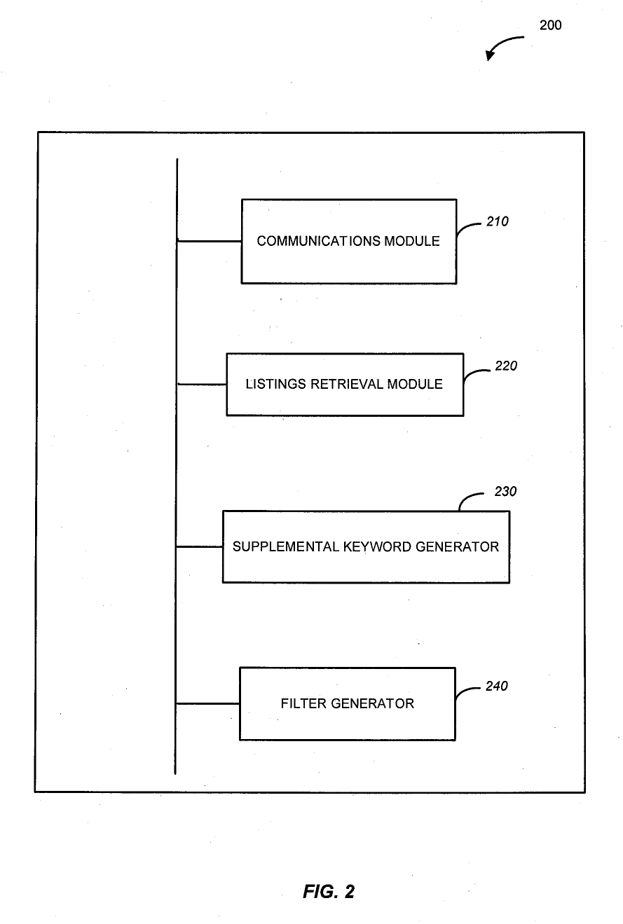

In one example embodiment, the storage system 150 may store listings of commerce items 152, as well as a mapping database 154. As described above, each listing has a title consisting of words describing characteristics of the commerce item represented by the listing. The mapping database 154 may store associations between keywords and categories, as well as a list of synonymous relationship which may be considered in generating system-supplied search terms. An example system to narrow generic searches may be described with reference to FIG. 2.

FIG. 2 is a block diagram of a system 200 to narrow generic searches using related search terms, in accordance with one example embodiment. As shown in FIG. 2, the system 200 includes a communications module 210, a listings retrieval module 220, a supplemental search term generator 230, and a filter generator 240. The communications module 210 may be configured to receive a search term from a user, for example, via the client systems 110 or 120 of FIG. 1. The listing retrieval module 220 may be configured to retrieve, from the storage system 150 of FIG. 1, listings of commerce items maintained by the on-line trading platform 142 of FIG. 1. The supplemental search term generator 230 may be configured to generate supplemental search terms based on the listings retrieved by the listing retrieval module 220 and the synonymous relationships maintained in the mapping database 154 of FIG. 1. The filter generator 240 may be configured to generate one or more filters based on the user-supplied search term received by the communications module 220, and present the filters, for example, in the form of categories and subcategories, to the user.

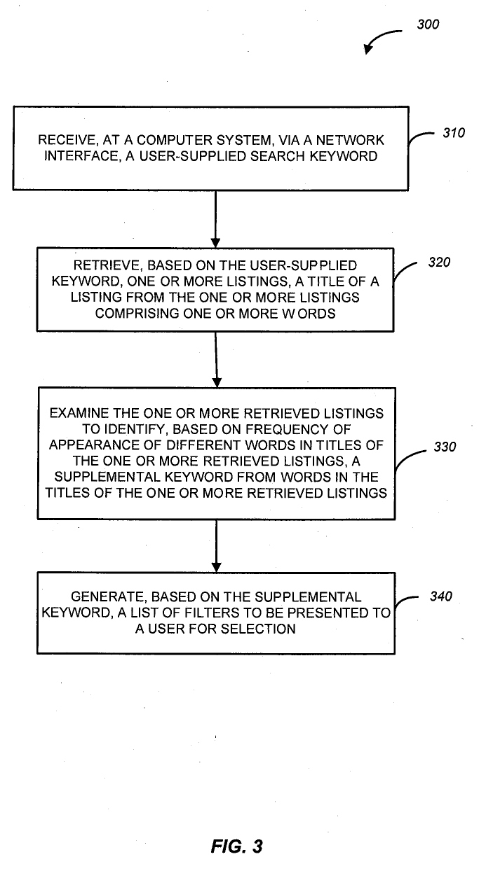

An example method to narrow generic searches using related search terms can be described with reference to FIG. 3. FIG. 3 is a flow chart of a method 300 to narrow generic searches using related search terms, in accordance with one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the communications module 210 of FIG. 2 receives, via a computer network interface, a search term supplied by a user. After the user-supplied search term is received, at operation 320, the listings retrieval module 220 of FIG. 2 retrieves listings of commerce items matching the user-supplied search term and the titles of these listings, from, for example, the storage system 150 of FIG. 1. At operation 330, the supplemental search term generator 230 of FIG. 2 examines the retrieved listings of commerce items to identify a supplemental search term based on how frequently various words (and, possibly, their respective synonyms) appear in the titles of retrieved listings. Then, at operation 340, the filter generator 220 of FIG. 2 generates a list of filters to be presented to the user. As explained above, in some embodiments, the list of filters for a previously-encountered user-supplied search term may be stored for later use and retrieved when the same user-supplied search term is encountered again.

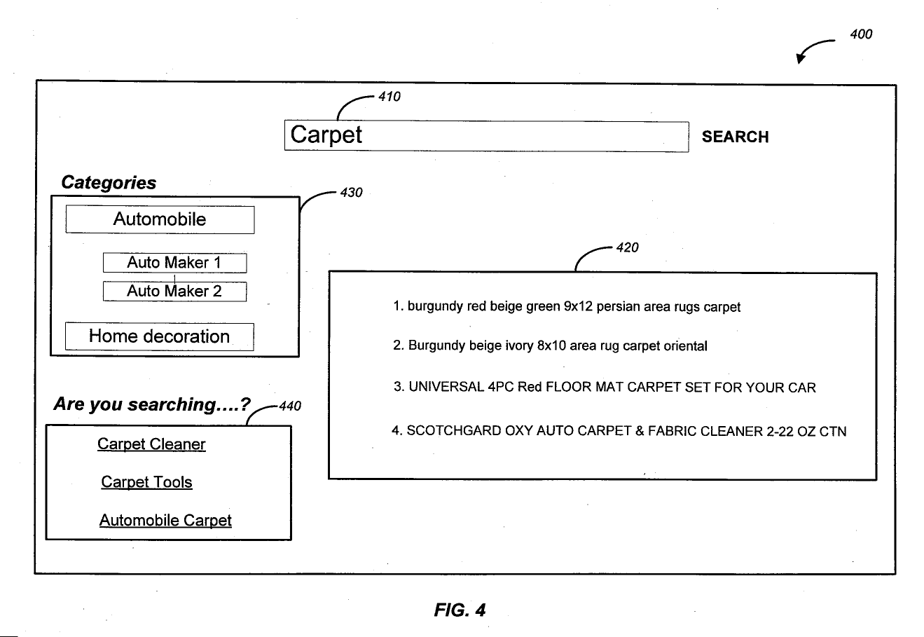

The list of filters may include one or more supplemental search terms identified at operation 330 or, in some embodiments, one or more categories (and, in some embodiments, subcategories) associated with the one or more supplemental search terms. As explained above, the associations of various words and phrases with one or more categories may be stored in the mapping database 154 of FIG. 1. Furthermore, the mapping database 154 may also store synonymous relationships among various words and/or phrases. All filters or only some of the filters may be provided to a user as displayed on a web page communicated to the user's computer system by a server system hosting an on-line trading platform. An example user interface that may be provided on a web page communicated to the user's computer system by a server system hosting an on-line trading platform may be described with reference to FIG. 4.

FIG. 4 is an example user interface 400 illustrating how the listings of commerce items, categories and subcategories, and system-generated search terms may be presented to a user. As shown in FIG. 4, the user interface 400 comprises a field 410, that may be used to obtain a user-supplied search term 410 (here, “Carpet”), and an area 420 to display listings retrieved as a result of a search performed based on the user-supplied search term entered in the field 410. Area 430 displays inferred categories and respective associated subcategories determined based on the user-supplied search term “carpet.” Shown in the area 430 are two categories (“Automobile” and “Home decoration”) and two subcategories (“Auto Maker 1” and “Auto Maker 2”). In addition to the categories and subcategories sown in the area 430, the user interface 400 includes an area 440 that displays a list of filters generated based on one or more system-generated search terms. As explained above, the filters may be the system-supplied search terms or one or more categories determined based on the system-supplied search terms. Shown in the area 440, are system-generated search terms “Carpet Cleaner,” “Carpet Tools,” and “Automobile Carpet.” The filters presented in the area 440 may be provided in a form of selectable controls configured to trigger filtering of the listings presented in the area 430 based on the selected filter.

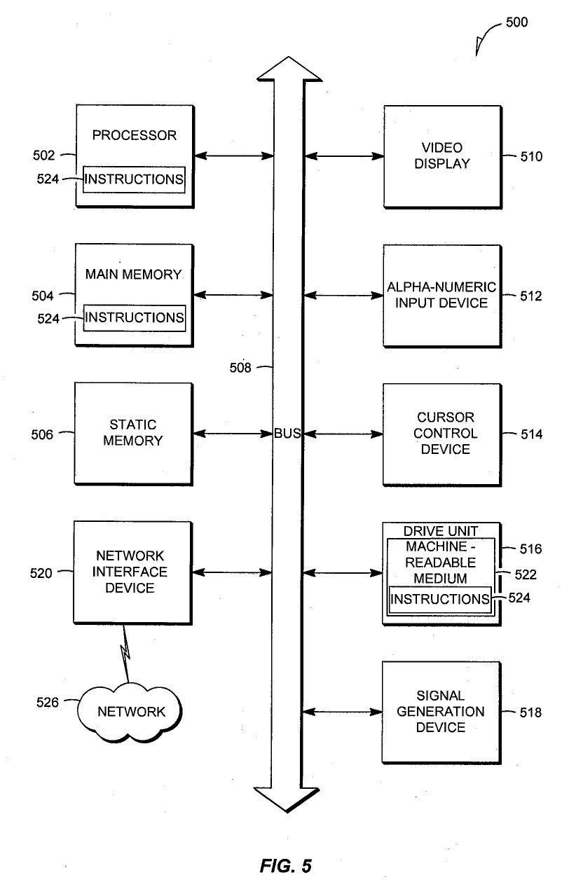

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, a method and system to narrow generic searches using related search terms has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

For example, while an embodiment has been described with reference to an on-line trading platform, a method and system may be implemented and utilized advantageously in the context of various other on-line platforms, as well as stand-alone applications.

1. A method comprising:
receiving, at a computer system via a network interface, a user-supplied search term;
retrieving, based on the user-supplied search term, one or more listings, a title of a listing from the one or more listings comprising one or more words;
examining the one or more retrieved listings to identify, based on frequency of appearance of different words in titles of the one or more retrieved listings, a supplemental search term from words in the titles of the one or more retrieved listings; and
based on the supplemental search term, generating a list of filters to be presented to a user for selection.

2. The method of claim 1, comprising:
receiving a selection of a filter from the list of filters; and
filtering the one or more retrieved listings based on the selection of the filter.

3. The method of claim 1, wherein the generating of the list of filters comprises including a phrase into the list of filters, the phrase comprising the user-supplied search term and the supplemental search term.

4. The method of claim 1, wherein the generating of the list of filters comprises:
determining a category associated with the supplemental search term; and
including the category into the list of filters.

5. The method of claim 1, wherein the examining the one or more retrieved listings to identify the supplemental search term comprises determining one or more synonyms of the user-supplied search term.

6. The method of claim 5, wherein the examining of the one or more retrieved listings to identify the supplemental search term comprises determining frequency of appearance of the user-supplied search terms and frequency of appearance of synonyms of the user-supplied search terms in the titles of the one or more retrieved listings.

7. The method of claim 6, wherein the examining the one or more retrieved listings to identify the supplemental search term comprises combining the frequency of appearance of the user-supplied search terms and the frequency of appearance of synonyms of the user-supplied search terms.

8. The method of claim 1, wherein the examining the one or more retrieved listings to identify the supplemental search term comprises excluding articles and prepositions in the titles of the one or more retrieved listings from the list of filters.

9. The method of claim 1, comprising generating a web page, the web page comprising the list of filters and a selection control associated with the list of filters

10. The method of claim 9, comprising communicating the web page to the user's computer system.

11. A computer-implemented system comprising:
a communications module to receive, at a computer system, via a network interface, a user-supplied search term;
a listings retrieval module to retrieve, based on the user-supplied search term, one or more listings, a title of a listing from the one or more listings comprising one or more words;
a supplemental search term generator to examine the one or more retrieved listings to identify, based on frequency of appearance of different words in titles of the one or more retrieved listings, a supplemental search term from words in the titles of the one or more retrieved listings; and
a filter generator to generate, based on the supplemental search term, a list of filters to be presented to a user for selection.

12. The system of claim 11, wherein the communications module is to receive a selection of a filter from the list of filters, the system comprising a filter module to filter the one or more retrieved listings based on the selection of the filter.

13. The system of claim 11, wherein the filter generator is to include a phrase into the list of filters, the phrase comprising the user-supplied search term and the supplemental search term.

14. The system of claim 11, wherein the filter generator is to:
determine a category associated with the supplemental search term; and
include the category into the list of filters.

15. The system of claim 11, wherein the supplemental search term generator is to determine one or more synonyms of the user-supplied search term.

16. The system of claim 15, wherein the supplemental search term generator is to determine frequency of appearance of the user-supplied search terms and frequency of appearance of synonyms of the user-supplied search terms in the titles of the one or more retrieved listings.

17. The system of claim 16, wherein the supplemental search term generator is to combine the frequency of appearance of the user-supplied search terms and the frequency of appearance of synonyms of the user-supplied search terms.

18. The system of claim 11, wherein t the supplemental search term generator is to exclude articles and prepositions in the titles of the one or more retrieved listings from the list of filters.

19. The system of claim 11, wherein the communications module is to communicate a web page to the user's computer system, the web page comprising the list of filters and a selection control associated with the list of filters.

20. A machine-readable non-transitory medium having instruction data to cause a machine to:
receive via a network interface, a user-supplied search term;
retrieve, based on the user-supplied search term, one or more listings, a title of a listing from the one or more listings comprising, one or more words;
examine the one or more retrieved listings to identify, based on frequency of appearance of different words in titles of the one or more retrieved listings, a supplemental search term from words in the titles of the one or more retrieved listings; and
generate, based on the supplemental search term, a list of filters to be presented to a user for selection.
